(19) United States
(12) Patent Application Publication
(10) Pub. No.: US 2026/0257308 A1
(43) Pub. Date: Sep. 3, 2026

(54) GRIPPING DEVICE FOR A HANDLING DEVICE, AND ALSO MECHANICAL ARRANGEMENT HAVING SUCH A HANDLING DEVICE

(71) Applicant: TRUMPF Werkzeugmaschinen SE + Co. KG, Ditzingen (DE)

(72) Inventors: Tim Gottschalk, Stuttgart (DE); Christoph Protze, Ringenhain (DE); Michael Harsch, Korntal- Münchingen (DE); Moritz Pietsch, Zittau (DE); Philipp Drechsler, Neukirch (DE); Philipp Nagel, Waldenbuch (DE); Stefan Krause, Wilthen (DE)

(21) Appl. No.: 19/658,769

(22) Filed: Apr. 27, 2026

Related U.S. Application Data
(63) Continuation of application No. PCT/IB2024/054559, filed on May 10, 2024.

(30) Foreign Application Priority Data
Oct. 30, 2023 (DE) 10 2023 129 990.5

(51) Int. Cl. B23Q 3/06

(52) U.S. Cl. CPC B23Q 3/06; B23Q 2240/002

(57) ABSTRACT

A gripping device for a handling device of a processing machine for handling plate-form workpieces, including a carrying structure at least one gripper bar, and gripping elements. The at least one gripper bar is arranged on the carrying structure and is oriented for displacement along an axis of the carrying structure and extends along a further axis of the carrying structure which differs from the displaceable axis. The gripping elements are arranged on an underside of the at least one gripper bar for handling the at least one workpiece. In an end region the at least one gripper bar has at least one gripper finger which, as viewed in a longitudinal axis of the at least one gripper bar, is designed tapered in relation to a main portion of the at least one gripper bar.

### CROSS REFERENCE TO RELATED APPLICATIONS

This application is a continuation of International Application No. PCT/IB 2024/054559 (WO 2025/093938A1), filed on May 10, 2024, and claims benefit to German Patent Application No. DE 10 2023 129 990.5, filed on Oct. 30, 2023. The aforementioned applications are hereby incorporated by reference herein.

### FIELD

The invention relates to a gripping device for a handling device of a processing machine and to a mechanical arrangement for handling at least one plate-form workpiece using a gripping device.

### BACKGROUND

DE 10 2020 128 656 A1 discloses a mechanical arrangement for the production of at least one plate-form workpiece from a metal sheet. This mechanical arrangement comprises a processing machine which comprises at least one processing device by which the at least one plate-form workpiece arranged on a workpiece support is processed. The supplied workpiece, in particular a plate-form blank material, can be cut into one or more workpieces and/or into a scrap skeleton. The processing device is assigned a loading station in which the at least one workpiece to be processed is provided so as to rest on a support surface. Furthermore, an unloading station is provided in which the at least one processed workpiece and/or the scrap skeleton is deposited on a deposit surface. This unloading station, or the deposit surface of the unloading station, is positioned below a workpiece support of the processing device. A linear axis device, comprising at least one linear axis that is oriented horizontally, accommodates a gripping device which is guided displaceably along a first movement axis. The gripping device comprises a carrying structure having gripper bars displaceably arranged thereon, which comprise gripping elements, in particular in the form of suction grippers, on their underside. This allows the workpiece that is to be processed to be transferred from the loading station to the processing device, and then the at least one processed workpiece can be deposited on the deposit surface of the unloading station, which is positioned below the workpiece support. Such displacement movements are time-consuming and require repeated starting and stopping of the displacement movement of the gripping device. Furthermore, separating the plate-form workpieces provided at the loading station is time-consuming without additional aids.

EP 1 967 301 A1 discloses a further mechanical arrangement for processing plate-form workpieces, in particular metal sheets. This mechanical arrangement comprises a processing device to which a plate-form workpiece is supplied by means of a handling device. After the processing of the plate-form workpiece by the processing device, the processed workpieces and/or the scrap skeleton or scrap skeleton parts are removed from the processing device by the handling device and transferred to an unloading station. The handling device comprises a carrying structure on which a plurality of gripper bars are provided for displacement relative to the carrying structure. Each gripper bar is provided with a plurality of vacuum suction elements by which the plate-form workpiece(s) can be gripped. The gripper bars have rectangular formats, which determine the gripping region. In the region of interference contours within the processing region of the processing device, which can be caused, for example, by a punching tool and/or a laser cutting head, dead zones can arise for the gripper bar, within which the workpiece(s) cannot be gripped.

### SUMMARY

In an embodiment, the present disclosure provides a gripping device for a handling device of a processing machine for handling plate-form workpieces, comprising a carrying structure at least one gripper bar, and gripping elements. The at least one gripper bar is arranged on the carrying structure and is oriented for displacement along an axis of the carrying structure and extends along a further axis of the carrying structure which differs from the displaceable axis. The gripping elements are arranged on an underside of the at least one gripper bar for handling the at least one workpiece. In an end region the at least one gripper bar has at least one gripper finger which, as viewed in a longitudinal axis of the at least one gripper bar, is designed tapered in relation to a main portion of the at least one gripper bar.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a mechanical arrangement according to an embodiment of the present disclosure;

FIG. 2 shows a perspective view of a gripping device of the mechanical arrangement according to FIG. 1;

FIG. 3 shows a perspective bottom view of the gripping device according to FIG. 2;

FIG. 4 shows a schematic top view of an interference contour in a processing region of the processing machine with a gripping device aligned with it;

FIG. 5 shows a perspective view of two interference contours in a processing region of the processing machine with a gripping device aligned with it;

FIG. 6 shows a schematic top view of an interference contour in a processing region of the processing machine with a gripping device aligned with it; and

FIG. 7 shows a perspective view of two interference contours in a processing region of the processing machine with a gripping device aligned with it.

### DETAILED DESCRIPTION

In an embodiment, the present disclosure provides a gripping device and a mechanical arrangement which has a processing device comprising such a gripping device that enables different removal positions adjacent to at least one interference contour to be flexibly assumed within the processing region of the processing machine for handling workpieces.

The foregoing is achieved by a gripping device for a handling device of a processing machine, which comprises a carrying structure on which at least one, preferably two, gripper bars are arranged for displacement along a first axis of the carrying structure and extend along a further axis which is oriented differently from the first axis of the carrying structure and has gripping elements, arranged on the underside of the gripper bar, for handling the workpieces, wherein in an end region the gripper bar has at least one gripper finger which extends in the longitudinal axis of the gripper bar and is designed tapered in relation to a main portion of the gripper bar. This gripper finger of the gripper bar enables the gripping device to be positioned directly adjacent to an interference contour, thereby significantly reducing or even eliminating previous dead zones for the gripper bar, which are formed due to the at least one interference contour within a processing space of the processing machine within which the gripper bar cannot be positioned to handle, in particular grip, a workpiece. This allows, in particular, improved and flexible removal of workpieces from the workpiece support after processing.

Preferably, the main portion of the gripper bar extends at least over a length along which the gripper bar is displaceably accommodated on the carrying structure. This means that the at least one gripper finger is oriented outside the spatial extent of the carrying structure.

Furthermore, preferably the main portion of the gripper bar extends from an end region to the gripper finger, preferably with a constant width. This allows one end region of the gripper bar to have a reduced gripping surface width due to the design of the gripper finger, while the opposite end of the gripper bar has an increased gripping width.

The gripper finger is preferably oriented asymmetrically with respect to the longitudinal axis of the gripper bar. In particular, the gripper finger is designed with an outer side flush or aligned with an outer surface of the main portion of the gripper bar. This allows an imaginary zero line to be formed in which both one outer side of the gripper finger and the one outer side of the main portion of the gripper bar lie. This facilitates the control of displacement movements of the gripping device between a loading station, an unloading station and/or a workpiece support of the processing device.

According to an embodiment of the gripper finger, the gripper finger, as viewed transversely to the longitudinal axis of the gripper bar, is designed to increase in width starting from its free end-face end towards the main portion. This allows for easy adjustment to dead zones around the interference contour by adjusting the length and/or width of the gripper finger in order to minimize or eliminate them.

The gripper finger preferably has a transition region that transitions seamlessly into the main portion. This ensures that a reduced gripping force due to the gripper finger only acts to the extent absolutely necessary to avoid dead zones around the interference contour.

Preferably, the gripper finger is attached, preferably detachably, to the main portion of the gripper bar by means of an interface. This also allows the gripper finger to be replaceable.

The gripper finger can be designed to with increasing width in stages starting from its free end face. This makes it possible to position gripping elements, in particular vacuum suction elements, in particular in corner regions where the width of the gripper finger increases in stages, so that a maximum gripping surface can be achieved by the gripping elements within the gripper finger.

Furthermore, the gripper finger can be lower than the main portion of the gripper bar. This allows even very low regions between the interference contour, in particular a processing head, and the workpiece support to be approached by this gripping device for the removal of at least one workpiece.

Advantageously, the gripper finger, as viewed starting from its free end face towards the main portion of the gripper bar, is designed with increasing height, in particular in stages. This allows for specific adjustment to at least one interference contour within the processing region of the processing device.

Preferably, the gripper bars each with the at least one asymmetrically oriented gripper finger are provided in the same manner aligned with one another on the carrying structure, so that the longitudinal sides of the gripper bars, along which the gripper finger and the main portion extend, are oriented in the same way.

The width of the gripper fingers on the gripper bar is preferably reduced to an extent that a free distance between two gripper fingers in two adjacent main portions of the gripper bars is equal to or less than the interference contour in the processing region of the processing device. This makes it possible for two adjacent gripper bars to enclose an interference contour in the best possible way.

Advantages of the present disclosure are further achieved by a mechanical arrangement for handling at least one plate-form workpiece, in particular made of a metal sheet, which comprises a processing machine, a loading station, an unloading station and a linear axis device, wherein a handling device can be displaced into the loading station, into the unloading station and/or into the processing machine by means of the linear axis device, and the handling device comprises a gripping device according to one of the embodiments described above. This makes it possible to displace the carrying structure of the handling device relative to the at least one interference contour within the processing machine in order to position the gripper fingers of the gripper bars directly adjacent to the interference contours for depositing or removing the at least one workpiece. This allows dead zones that can form around the interference contour or contours to be avoided or eliminated. Furthermore, the removal positions can be flexibly controlled.

Embodiments of the present disclosure are described and explained in more detail below by means of the examples illustrated in the drawings. The features that can be derived from the description and the drawings can be used individually or in any combination together according to the present disclosure.

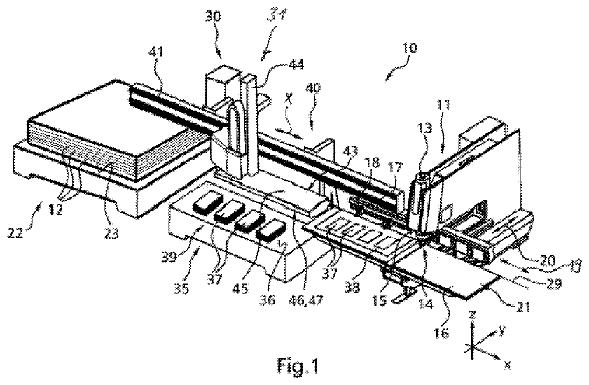

A mechanical arrangement 10 is shown in FIG. 1. This mechanical arrangement 10 comprises a processing machine 11 which is designed for processing a plate-form workpiece 12. The plate-form workpiece 12 can be processed by cutting and/or by forming and/or embossing or the like. This processing machine 11 comprises a processing device 13 by means of which the processing can be carried out. This processing device 13 can have a punching head 14 and/or a laser processing head 15. The processing machine 11 can have a C-shaped frame or a closed or O-shaped frame. The processing device 13 is arranged on the frame in a manner pointing towards a workpiece support 16. The workpiece 12 to be processed rests on a workpiece support 16 of the processing machine 11 during processing of the workpiece. The workpiece 12 is held during processing by a holding device 17, which preferably comprises clamps 18. The holding device 17 is displaceable along an X-axis, which corresponds to a first movement axis of the mechanical arrangement 10. The holding device 17 allows the plate-form workpiece 12 to be displaced in relation to the processing device 13 in the X-direction of the workpiece plane by means of a conventional drive 19 indicated by an arrow. In a Y-direction of the workpiece plane, the workpiece 12 can be displaced by a further drive 20. This Y-direction corresponds to a second movement axis of the mechanical arrangement 10. In this way, the workpiece 12 can be displaced in the X-direction and/or Y-direction in relation to the processing device 13 for processing on the workpiece support 16. The working region 21 of the processing machine 11 is defined by the displacement movement in the X-direction and Y-direction of the workpiece support 16 relative to the processing device 13. In order to receive the plate-form workpiece 12 in the defined manner for processing in the processing machine 11, a zero line 29 is provided, which extends along the longitudinal side of the workpiece support 16 facing the holding device 17 or is formed by the holding device 17. This provides a defined stop and a defined orientation of the workpiece 12 to be processed in the Y-direction.

The mechanical arrangement 10 also comprises a loading station 22. This loading station 22 has a support surface 23 on which the at least one plate-form workpiece 12, preferably a plurality of plate-form workpieces 12, are stacked on top of each other. The support surface 23 can be designed in the form of a palette. The plate-form workpiece 12 can also be placed directly onto the support surface 23 using a handling device 31. In the loading station 22, a blank material, i.e. an unprocessed plate-form workpiece 12, is preferably provided. An already partially processed, plate-form workpiece can also be provided for further processing. A separation apparatus 30 can be provided in a corner region 27 of the loading station 22. This separation apparatus 30 allows the uppermost plate-form workpiece 12 to be lifted from the plate-form workpiece below it, at least in one corner region. At the same time, it can be checked that only a plate-form workpiece 12 is lifted. Subsequently, the plate-form workpiece 12 can be gripped in the loading station 22 using a gripping device 43 and removed from the loading station 22. The separation apparatus 30 is known from DE 10 2022 105 125 A1, to which reference is made in full.

The mechanical arrangement 10 also comprises an unloading station 35. This unloading station 35 comprises a deposit surface 36 on which at least one processed, plate-form workpiece 37 and/or a scrap skeleton 38 resulting from the processing of the plate-form workpiece 12 can be deposited. The size of the deposit surface 36 can form the working region 39 of the unloading station 35. The deposit surface 36 can be designed using pallets or the like, so that these can be easily removed and prepared for further transport.

The handling device 31 can have a linear axis device 40, which has at least one horizontally oriented linear axis 41. A gripping device 43 is displaceably guided along this linear axis 41 in the first movement axis (X-axis). This linear axis device 40 can also have a second linear axis (Y-axis) which is perpendicular to and oriented in the same plane as the first linear axis 41. In this case, the gripping device 43 can be controlled for displacement along a second movement axis (Y-axis). The horizontally oriented linear axis 41 extends in such a way that the gripping device 43 can be displaced into the working region 24 of the loading station 22, into the working region 21 of the processing machine 11 and into the working region 39 of the unloading station 35. The linear axis device 40 can also comprise a lifting unit 44. This lifting unit 44 allows the gripping device 43 to be displaceable along a Z-axis, which corresponds to a third movement axis. Alternatively, the lifting unit 44 is assigned to the gripping device 43.

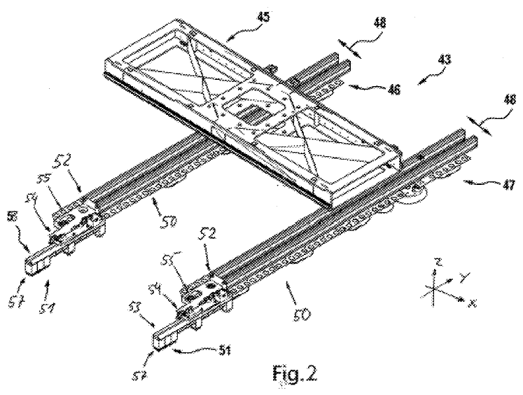

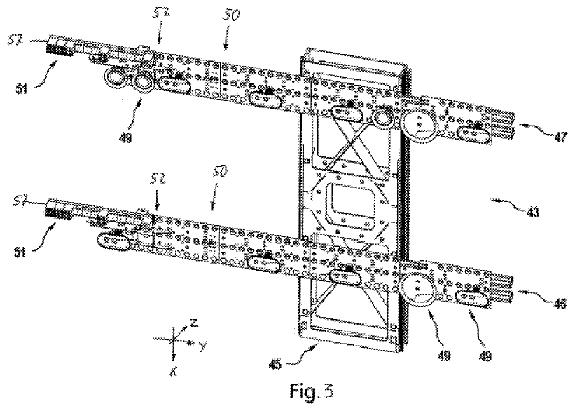

FIG. 2 shows a perspective view of an exemplary gripping device 43. FIG. 3 shows a perspective bottom view of the gripping device 43 according to FIG. 2. The gripping device 43 comprises at least one, preferably two, gripper bars 46, 47, which are advantageously received on a carrying structure 45 for displacement relative to each other. The gripper bars 46, 47 are arranged on the carrying structure 45 for displacement at least in and counter to the second movement axis (Y-axis).

The gripping device 43 comprises a carrying structure 45. The carrying structure 45 can be arranged on the lifting unit 44. The two gripper bars 46, 47 are displaceably accommodated on one underside of the carrying structure 45. This displaceable arrangement is oriented such that the gripper bars 46, 47 are displaceable according to the arrows 48 at a distance from each other and independently of each end stop of the carrying structure 45. The carrying structure 45 of the gripping device 43 is aligned with the horizontal linear axis 41 such that the displacement direction according to arrow 48 is oriented in and counter to the second movement axis (Y-axis).

The gripper bars 46, 47 have a plurality of gripping elements 49 on their underside. Vacuum suction cups or suction gripping elements are preferred. These can differ in shape and/or size and can also be arranged in any configuration relative to each other. A gripper finger 51 is provided in one end region of the gripper bar 46, 47 and is tapered in width with respect to the opposite end region of the gripper bar 46, 47. This gripper finger 51 can be used to receive very small parts. The gripper finger 51 is oriented asymmetrically with respect to the gripper bar 46, 47. Advantageously, this extends along an outer side of the gripper bar 46, 47. The gripper bars 46, 47 are provided on the carrying structure 45 with the same orientation with respect to the asymmetric arrangement of the gripper fingers 51.

The gripper bar 46, 47 preferably comprises a main portion 50. This main portion 50 preferably extends beyond the width of the carrying structure 45, which is aligned with the Y-axis. The main portion 50 of the gripper bar 46, 47 is preferably of the same width along its length. The gripper finger 51 is provided at one end-face end of the main portion 50. This can be detachably connected to the main portion 50 via an interface 52. This makes it possible to easily attach different geometries of the gripper fingers 51 to the gripper bar 46, 47. This makes it possible to easily adjust the gripping device 43 to at least one interference contour 61, 63 (FIGS. 4 to 7) of the processing device 13.

FIGS. 2 and 3 show an exemplary geometry for a gripper finger 51. This gripper finger 51 comprises a first stage 53, which extends from a free end face 57 towards the main portion 50. This first stage 53 has a constant width. For example, the first stage 53 is followed by a second stage 54 of the gripper finger 51. This second stage 54 can, for example, be wider than the first stage 53. The second stage 54 can be at the same height as the first stage 53 or even higher. The exemplary embodiment also shows a third stage 55 of the gripper finger 51. This third stage 53 is wider than the second stage 54 and the first stage 53. The height of the third stage can also be adjusted to 55. This interference contour 61 is formed, for example, by the processing device 13, in particular the punching head 14.

FIG. 4 shows a schematic top view of the interference contour 61. Furthermore, the plate-form workpiece 12 is shown, which rests on a workpiece support 16 and is positioned below the interference contour 61 and extends at least partially beyond the interference contour 61. The interference contour 61 is formed, for example, by an external geometry of the punching head 14. In the exemplary embodiment, an elongated attachment 62 is provided on the punching head 14 and also forms the interference contour 61. Furthermore, the top view shows the position of two adjacent gripper bars 46, 47 of the gripping device 43. The gripper finger 51 of the gripper bar 47, for example, is positioned with its first stage 53 directly adjacent to the elongated attachment 62. The first stage 53 of the gripper finger 51 is adjusted, for example, to the elongated attachment 62, so that it is made possible to position the gripper finger 51 directly adjacent to the interference contour 61. At the same time, the end-face end 57 of the gripper finger 51 is aligned directly with the punching head 14. Due to the format of the plate-form workpiece 12, 37, the adjacent gripper bar 46 is positioned adjacent to the interference contour 61 and the elongated attachment 62, which also forms an interference contour. If the plate-form workpiece 12, 37 is narrower, the gripper bar 46 can be positioned so as to bear against the gripper bar 47, so that, for example, the gripper finger 51 of the gripper bar 46 can also be positioned directly adjoining the elongated attachment 62. In the exemplary configuration of the interference contour 61 with the elongated attachment 62, this obviously eliminates dead zones adjoining the interference contour 61 because of the formation of the gripper fingers 51 on the gripper bars 46, 47.

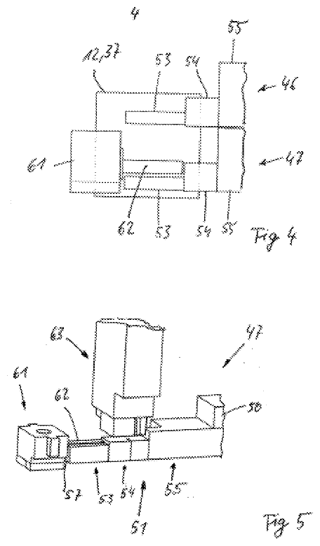

FIG. 5, in addition to the interference contour 61, which is formed by the punching head 14 and the elongated attachment 62, shows a further interference contour 63. The further interference contour 63 is formed, for example, by the laser processing head 15. To also take this interference contour 63 into account, the gripper finger 51 is adjusted in height with respect to the stage 53, 54, 55. Thus, the gripper finger 51 of the gripper bar 46, 47 can be adjusted not only to a single interference contour 61 but to several interference contours 61, 63.

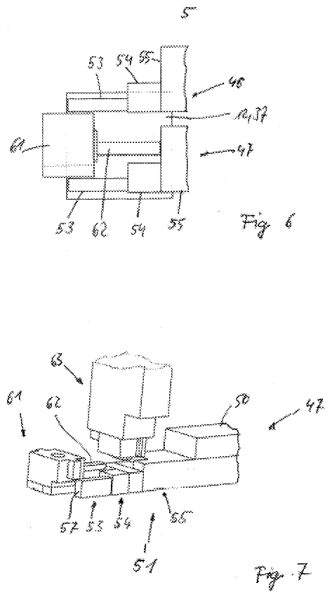

FIG. 6 shows a further top view of the interference contour 61 with a plate-form workpiece 12, 37. The gripper fingers 51 of the gripper bars 46, 47 are, for example, positioned to the side of the interference contour 61. This gripper finger 51, for example, has a first stage 53 and a second stage 54, which transitions via the interface 52 into the main portion 50 of the gripper bar 46, 47. The gripper finger 51 is adjusted in such a way that the first stage 53 of the gripper finger 51 can be positioned laterally and adjacent to the interference contour 61 and the interface 52 to the main portion 50 is formed in such a way that this interface 52 bears against the end face of the further elongated attachment 62. Alternatively, it is also provided for the gripper finger 51 to have three stages 53, 54 and 55, so that the interface 52 to the main portion 50 is provided on the third stage 55.

FIG. 7 shows, by way of example, the interference contour 63 in addition to the interference contour 61 according to FIG. 6. Owing to the vertical design of the gripper finger 51 in stages with the first stage 53, the second stage 54 and/or the third stage 55, the further interference contour 63 can be taken into account. At the same time, an end face 57 of the gripper finger 51 can also be positioned to the side of the interference contour 61.

The gripping device 43 thus has the advantage that the gripper finger 51 arranged on the gripper bar 46, 47 enables different depositing and/or removal positions to be flexibly assumed for handling plate-form workpieces within a processing region or directly adjoining the processing device 13.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A gripping device for a handling device of a processing machine for handling plate-form workpieces, comprising:
a carrying structure;
at least one gripper bar which is arranged on the carrying structure and which is oriented for displacement along an axis of the carrying structure and extends along a further axis of the carrying structure which differs from the displaceable axis; and
gripping elements arranged on an underside of the at least one gripper bar for handling the at least one workpiece,
wherein in an end region the at least one gripper bar has at least one gripper finger which, as viewed in a longitudinal axis of the at least one gripper bar, is designed tapered in relation to a main portion of the at least one gripper bar.

2. The gripping device according to claim 1, wherein the main portion of the at least one gripper bar extends at least over a length along which the at least one gripper bar is displaceably accommodated on the carrying structure.

3. The gripping device according to claim 1, wherein the main portion of the at least one gripper bar extends from a free end region to the at least one gripper finger and is preferably of a same width along the main portion.

4. The gripping device according to claim 1, wherein the at least one gripper finger is oriented asymmetrically with respect to the longitudinal axis of the at least one gripper bar.

5. The gripping device according to claim 1, wherein the at least one gripper finger is aligned with its outer side in a manner flush or aligned with an outer side of the main portion of the at least one gripper bar.

6. The gripping device according to claim 1, wherein the at least one gripper finger transitions into the main portion of the at least one gripper bar at an interface, and preferably the at least one gripper finger is detachably attached to the main portion in the interface.

7. The gripping device according to claim 1, wherein the at least one gripper finger is designed with increasing width, as viewed transversely to the longitudinal axis of the at least one gripper bar, starting from its free end face towards the main portion.

8. The gripping device according to claim 7, wherein the at least one gripper finger, starting from its free end face towards the main portion, has at least one stage in which the at least one gripper finger increases in width.

9. The gripping device according to claim 7, wherein the at least one gripper finger is formed lower at least on the free end face than the main portion.

10. The gripping device according to claim 9, wherein the at least one gripper finger is designed with increasing height, starting from the free end face of the at least one gripper finger towards the main portion, and is preferably designed with increasing height with each stage.

11. The gripping device according to claim 1, wherein the at least one gripper bars each with the at least one asymmetrically designed gripper finger are arranged in the same manner aligned with one another on the carrying structure, so that outer sides of the at least one gripper bars, along which the at least one gripper finger extends, are each aligned with a same end face of the carrying structure.

12. The gripping device according to claim 1, wherein a width of the at least one gripper fingers is reduced to an extent that a free distance between the at least one gripper fingers of two adjacent main portions of the at least one gripper bars is equal to or less than an interference contour.

13. A mechanical arrangement for handling at least one plate-form workpiece, comprising:
a processing machine which comprises at least one processing device which processes the at least one plate-form workpiece arranged on a workpiece support, wherein at least one unprocessed workpiece and/or a scrap skeleton can be produced;
a loading station in which the at least one plate-form workpiece to be processed is provided so as to rest on a support surface;
an unloading station in which the at least one processed workpiece and/or the scrap skeleton can be positioned on a deposit surface;
a linear axis device which comprises at least one linear axis and which is oriented horizontally and forms a first movement axis for a gripping device which is guided displaceably on the at least one linear axis, wherein the gripping device comprises at least one gripper bar which is displaceable on a carrying structure of the gripping device along a second movement axis which is perpendicular to the first movement axis and lies in a horizontal plane,
wherein the processing machine, the loading station, and the unloading station are aligned with the linear axis device, and
wherein the gripping device is designed as the gripping device according to claim 1.
